(19) United States
(12) Patent Application Publication
(10) Pub. No.: US 2004/0258811 A1
(43) Pub. Date: Dec. 23, 2004

(54) Treated closures 3

(76) Inventors: Phillip Mackie, Barker (AU); Darren Lange, Gawler (AU); Russell Johnson, Anwatson (AU); Leanne Britcher, Valley View (AU); Janis Matisons, Marion (AU); Terry Wilks, North Adelaide (AU); Rosalind Ma, Prospect (AU); Mark Franson, Greenwith (AU)

Correspondence Address: KLAUBER & JACKSON, 411 HACKENSACK AVENUE, HACKENSACK, NJ, 07601

(21) Appl. No.: 10/826,143

(22) Filed: Apr. 16, 2004

Related U.S. Application Data
(63) Continuation of application No. 10/009,511, filed on Apr. 29, 2002, now abandoned.
Application No. 10/009,511 is a 371 of international application No. PCT/AU00/00367, filed on Apr. 20, 2000.

(30) Foreign Application Priority Data
Apr. 22, 1999 (AU) PP 9894

(51) Int. Cl. B05D 3/06

(52) U.S. Cl. 426/392

(57) ABSTRACT

In a first aspect, the present invention provides a method for producing a coating or diffusion layer on a substrate (e.g. a cork) for use in contact with a food product or beverage, said coating or diffusion layer preventing or inhibiting passage therethrough (e.g. from a cork to an alcoholic beverage) of flavour-active or odour-active compounds (commonly known as cork taint), and said method comprising applying to the surface of said substrate an effective amount of a copolymer comprising a flexible component and a retentive component, said flexible component being sufficiently flexible to allow the coated substrate to undergo compression and recovery (e.g. so as to allow a coated cork according to the present invention to be compressed and then to recover during the bottling process) and said retentive component being able to bind with or otherwise retain flavour-active or odour-active compounds. In a second aspect, the present invention provides a coated substrate, and in particular a coated natural or synthetic cork, produced according to that method.

### BACKGROUND TO THE INVENTION

This invention provides improved closures for use in connection with food or beverages. One application is in relation to closures for wine bottles. Wine bottles have traditionally been stoppered with corks made from natural cork material. However, this material can be subject to initial flaws, or deteriorate in use, resulting in contamination or spoilage of the wine. For example, oxidation of the wine, due to permeation of oxygen through the cork into the wine, results in vinegar flavour. “Cork taint”, due to the presence of trichloro-anisoles (TCA) and other undesirable flavour-active or odour-active compounds in the cork, imparts a musty or mouldy smell and flavour to the wine. Leakage can also be a problem. Furthermore, cork is a relatively expensive material, as most supplies still come from Portugal.

None of the alternatives to natural corks proposed to date have been entirely satisfactory.

Synthetic “corks” and screw-cap stoppers have been used in the wine industry, but have not yet been tested adequately over the prolonged storage periods of quality red wines. There is some indication, however, that synthetic “corks” may impart flat flavours to wines. Furthermore, there is considerable consumer resistance to use of synthetic “corks” and screw-cap stoppers, particularly for quality wines. A further disadvantage is that synthetic “corks” are generally far more difficult to remove, using a hand-operated corkscrew, than natural corks.

Accordingly, there have been numerous attempts to improve on natural cork stoppers, by coating or impregnating them.

The first cork coatings were simply lubricants such as paraffin and Vaseline. These merely ensured that the cork was easier to insert into the bottle and later remove, without disintegration. The other problems associated with cork stoppers were not addressed.

Currently, materials used in surface treatment of corks include oils and silicone resins, emulsions of various formulations, as well as some synthetic coatings. These coatings do prevent leakage of the wine, but do not provide a barrier against taint and oxidation.

Many of these coatings also present problems with the coating coming off the cork and leaving an oily layer on the wine surface. Hybrid corks have been moulded from natural cork and synthetic cork cells made from a synthetic polymer. The synthetic cells fill the gaps between the cork cells, and a binding agent (such as polyurethane) is used to bind the cells together. However, hybrid corks have to date proved unsatisfactory, as they often leak and can disintegrate and be difficult to extract from a bottle.

The present invention provides an improved closure having a surface coating or diffusion layer comprising an appropriate polymer. This coating or diffusion layer has many properties which are of benefit when used (for example) in relation to corks (either natural or synthetic) for wine bottles. The coating or diffusion layer limits oxygen permeability, inhibits or prevents the diffusion of trichloro-anisoles (TCA) and other flavour-active or odour-active compounds from the cork to the alcoholic beverage, adheres strongly to the cork and/or penetrates into the surface of the cork, is sufficiently flexible to be capable of withstanding compression and decompression during the corking process, enables the coated cork to be readily extracted from the bottle, reduces or prevents wine leakage, is resistant to sulphur dioxide, and has long life under alcoholic beverage conditions.

These coatings or diffusion layers are also applicable to substrates other than cork (eg packaging and wrapping materials) which are in contact with food products or beverages.

### SUMMARY OF THE INVENTION

According to the present invention, a copolymer comprising a flexible component and a retentive component is applied as a surface coating or diffusion layer to a substrate for use in contact with food products or beverages, said flexible component being sufficiently flexible to allow the coated substrate to undergo compression and recovery (eg so as to allow a coated cork according to the present invention to be compressed and then to recover during the bottling process) and said retentive component being able to bind with or otherwise retain flavour-active or odour-active compounds (commonly known as taint compounds). The flexible component of the copolymer may be silicon-based, but the copolymers of the present invention are not restricted to those comprising silicon-based monomers. Other flexible monomers providing the necessary requirements for the coating may also be used. Two or more copolymers may be blended together to achieve the desired properties.

The substrate may, for example, be a bottle closure (such as. a cork), packaging and wrapping materials (such as packaging for cheese), or a bottle or other container.

As mentioned above, the copolymer comprises a flexible (eg silicon-based) component and a retentive component that retains flavour-active or odour-active compounds. This multi-component polymer structure acts as a partial physical barrier to the passage of gases and undesirable flavour-active or odour-active compounds, whilst having the physical properties (in particular, flexibility) required during the treatment and packaging processes. In particular, the polymer coating or diffusion layer of the present invention will prevent any undesirable flavour-active or odour-active compounds migrating from a cork to an alcoholic beverage. The copolymer is also selected for other advantageous properties, such as adhering strongly to the substrate and/or penetrating into the surface of the substrate. Furthermore, if the substrate is a cork, the copolymer coating or diffusion layer must enable the coated cork to be readily extracted from the bottle, prevent wine leakage, and have long life under alcoholic beverage conditions. Preferably, the copolymer coating or diffusion layer will also be resistant to sulphur dioxide and changes in pH.

### DETAILED DESCRIPTION OF THE INVENTION

The copolymers of the present invention may be graft, alternating or block copolymers, or mixtures thereof. Suitable copolymers are described in the following references:

J.Wen, G. L. Wilkes, Polymer Bulletin,1996, 37, 51-57

J. Hazziza-Laskar, G. Helary, G. Sauvet, J. Appl. Polym. Sci., 1995, 58, 77-84 Tezuka et. al., Macromolecules, 1995, 28(24), 8251-8258

P. Schofield, C. Cohen, C. K. Ober, Polymer Gels & Networks, 1998, 6(3-4), 291-300

T. Furuzuno, K. Seki, A. Kishida, T. Ohshige, K. Waki, I. Maruyama, M.

Akashi, J. Appl. Polym. Sci.,1996, 59, 1059-1065

D. Spridon, L. Panaitescu, D. Ursu, C. V. Uglea, I. Popa, R. M. Ottenbrite, Polymer International, 1997, 43, 175-181

J. C. Schrnidhauser, K. L. Longley, J. Appl. Polym. Sci., 1990, 39, 2083-2096

L. Lestel, H. Cheradame, S. Boileau, Polymer, 1990, 31, 1154-1158

G. E. Hahn, K. D. Klein, I. Yilgor, C. Could; In Silicone-Containing Polymers;

Editor, R. G. Jones; The Royal Society of Chemistry: Cambridge, UK; 1995; pp 81-87

M. A. Sherman, J. P. Kennedy, J. Appl. Polym. Sci., 1998, 30, 1891-1899

Examples of such copolymers are:

polyvinylacetate (PVA) copolymers

polyurethane copolymers and ionomers

terephthalate copolymers

styrene-acrylonitrile (SAN)/acrylonitrile-butadiene-styrene (ABS) copolymers

(vinylidene) copolymers

epoxy copolymers

amnide copolymers

Bisphenol copolymers

Bisphenol A (BPA) - epichlorohydrin copolymers

poly (methyl) methacrylate copolymers

poly (methacrylic acid) copolymers

cellulose copolymers

polyethylene vinyl alcohol copolymers

silane and siloxane copolymers, eg comprising polyethylene glycol (PEG),

isoprene, butadiene, lactone, amino, terephthalate, amino acid, heterocyclic,

hydride (SiH), thiol or epoxy functionalities,

and mixtures thereof, provided that they comprise the required flexible and retentive components (as defined above).

PVA and functionalised siloxanes (eg comprising SiH or arnino groups) have been found to be particularly suitable components of the copolymers.

Modifications of the polymers may be necessary to improve resistance to reactions with various components of the food product or beverage (eg wine).

The polymer coatings and diffusion layers of the present invention may be used in conjunction with lubricants, such as paraffin or Vaseline, to make the coated cork easier to insert into a bottle and later extract.

The method of applying the copolymer to the substrate will be dependent on the nature of the copolymer and of the substrate, and will include such conventional processes as film formation, adsorption from solution, reactive-adhesion to cork, melt polymer application (eg thermoforming, vacuum forming and plasma polymerisation), UV curing and Corona discharge processes. The polymers may also be components of multi-layer laminate structures.

Preferably, the substrate (eg cork) is prewashed with a solution (eg ethanol, water or a mixture of ethanol and water) and then dried before coating, to remove any surface contamination.

The following examples form an overview of some of the technologies which may be used. These examples are illustrative, but not restrictive, of the present invention.

### DESCRIPTION OF THE DRAWINGS

FIGS. 1A-C are the results of Scanning Electrode Microscopy (SEM) of the coating of Example 3.

FIGS. 2A-D are the results of SEM of the coating of Example 8.

### SENSORY EVALUATION TESTS

Corks were spiked with TCA by soaking 100 corks in 1.5 litres of 100 mg/L of solution of TCA in absolute ethanol for 24 hours. The corks were then removed from the solution and allowed to dry in a 40° C. oven for 24 hours before being submitted for sensory evaluation to ensure that the corks have TCA odours. These corks were then coated with the coatings given below and sent for sensory evaluation.

Coated TCA spiked corks were immersed in approximately 150 mL of white wine for 24 hours. The wine was evaluated for unacceptable odours by a team of experts, being a group of no less than three qualified trained sensory evaluators. The samples were given a rating of between 1 and 4. A rating 1 indicated a slight odour, rating 2 a moderate odour, rating 3 a strong odour and rating 4 a very strong odour. A rating of 2 or less was acceptable. The sensory evaluation tests related primarily to TCA odours, which were indicative of likely problems relating to undesirable flavour-and odour-active compounds.

Coatings

A TCA spiked cork and a non-TCA cork were coated with the coatings described below and subjected to sensory evaluation.

### EXAMPLE 1

### Polyurethane

A mixture of 1,3-Bis(aminopropyl)tetramethyldisiloxane (3 g, 0.012 mol) and caprolactone (4.1 g, 0.036 mol) was heated to 75° C. under nitrogen before the catalyst, stannous octoate (0.1 mL), was added. The mixture was refluxed for 2 hours at 75° C. before the temperature was raised to 140° C. for a further 1.5 hours. The product was then allowed to cool.

A mixture of the above product (7 g, 0.012 mol), dimethylolpropionic acid (0.8 g, 5.95 ×10−³ mol), hexamethylenediisocyanate (3 g, 0.018 mol), acetone (20 mL) and dibutyltin dilaurate (0.1 mL) was stirred under nitrogen at 35° C. for 15 minutes and then allowed to cool. Triethylamine (1 mL) was added and stirred continuously for 30 minutes, before carefully adding 30 mL of distilled water. The acetone was removed in vacuo to give the water-dispersed polyurethane.

Corks were dipped into this coating and allowed to cure in an oven at 40° C. for 24 hours.

Sensory evaluation tests gave a rating of 2 or less.

### EXAMPLE 2

### Polybutadiene/Triethoxysilane Copolymer

A mixture of polybutadiene (Mn=400, 9.1 g, 0.023 mol), triethoxysilane (4.2 g, 25 mmol) and H₂PtCl₆ (0.8 mL), in toluene, was refluxed for 24 hours under nitrogen at 110° C. The solution was then allowed to cool, and solvent and excess triethoxysilane was evaporated under vacuum to give a pale yellow oil as a product.

The polymer was diluted to 25% (v/v) with ethanol and the cork was dipped into this coating and then dried at 40° C. for 24 hours.

Sensory evaluation tests gave a rating of 2 or less.

### EXAMPLE 3

### Two Dip Process (Epoxysilicone/Aminopropyltriethoxysilane)

Corks were dipped into an epoxysilicone solution and then into a 0.1% solution of Aminopropyltriethoxysilane in water. The coating was allowed to cure at 40° C. for 1 hour.

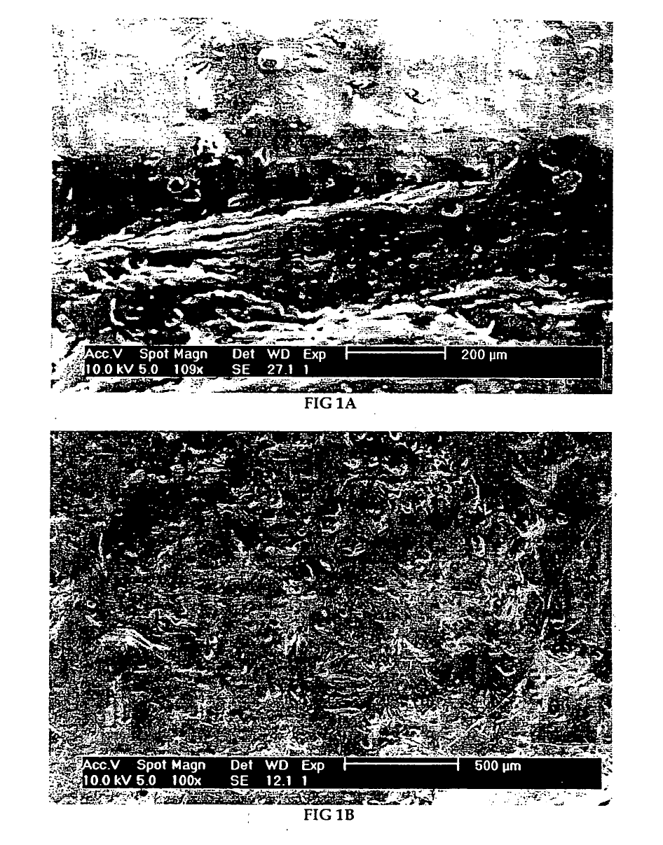

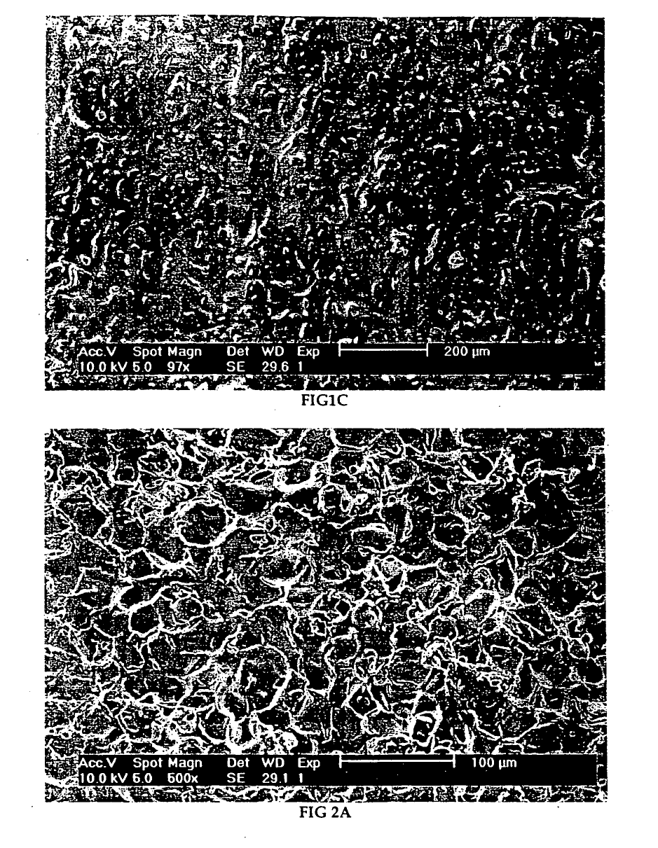

Sensory evaluation tests gave a rating of 2 or less. Scanning Electrode Microscopy (SEM) showed an obvious smooth layer of coating (FIG 1A). The coating was undisturbed after a compression test (FIG. 1B) and there was no visible deterioration of the coating even after being immersed in white wine for 24 hours (FIG. 1C).

### EXAMPLE 4

### Polyethylene/Polyethylene Vinyl Alcohol/Polyethylene Laminate Film

A polyethylene/polyethylene vinyl alcohol/polyethylene laminate film was wrapped around the cork and sealed with a heat gun. Sensory evaluation tests gave a rating of 2 or less.

### EXAMPLE 5

### Poly(Dimethylsiloxane-alt-Diphenyl)Copolymer

Poly (Dimethylsiloxane-alt -diphenyl) copolymer was synthesised as described in: Clarke, S.; Graiver, D.; Matisons, J.; and Owen, M., U.S. Patent Appl. DC4689 1999 and EP Pat Appl. 993 093 48.3. The corks were dipped in a 25% solution of the polymer with hexane. The hexane was removed bv evaporation in an oven at 60° C. for 24 hours.

Sensory evaluation tests gave a rating of 2 or less.

### EXAMPLE ≢

### Polyacrylate/Methacrylate

A cork was dipped into a solution of 46% acrylic methacrylic acid ester in water and then allowed to dry in a 40° C. oven overnight. The coated cork was then submitted for testing.

Sensory evaluation tests gave a rating of 2 or less.

### EXAMPLE 7

### Polyvinylacetate Emulsion/Aminosiloxane Emulsion

The cork was dipped into a solution consisting of 75% Polyvinylacetate emulsion and 25% Aminosiloxane emulsion. The coating was then cured in an oven at 38° C. for 1 hour. The coated cork was then submitted for testing. Sensory evaluation tests gave a rating of 2 or less.

### EXAMPLE 8

### Polyvinylacetate/Polymethylhydrogen Siloxane Emulsion

The coating formulation consisted of a mixture of 75 mL of polyvinylacetate emulsion (PVA) and 25 mL of polymethylhydrogen siloxane emulsion. 100 corks were placed into a tumbler and 20 mL of the coating formulation was distributed casually over the corks. The corks were tumbled, to evenly distribute and dry the coating, for 1 hour at 40° C.

Sensory evaluation and Gas Chromatography/Mass Spectroscopy (GC/MS) results showed that no TCA or other undesirable odours were detected.

In particular, sensory evaluation tests gave a rating of 2 or less.

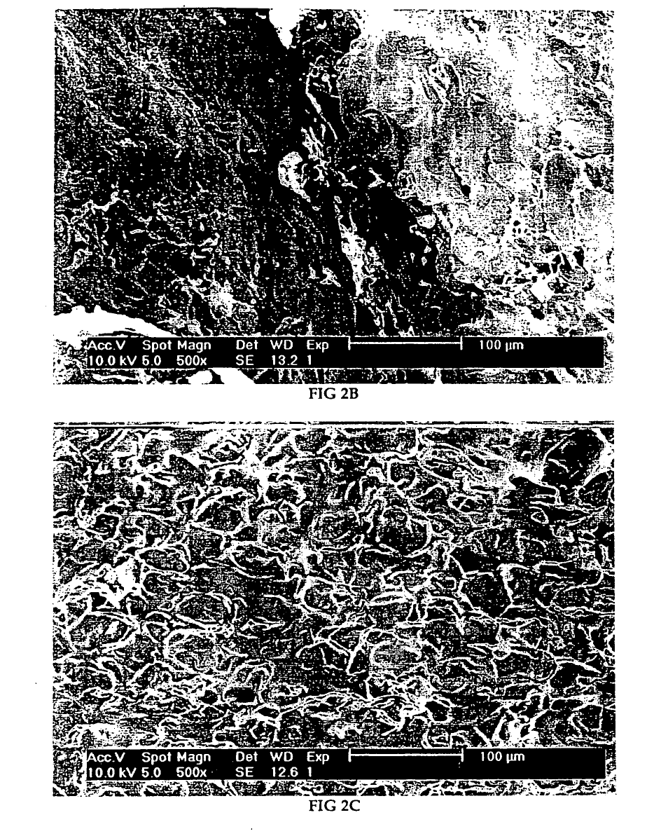

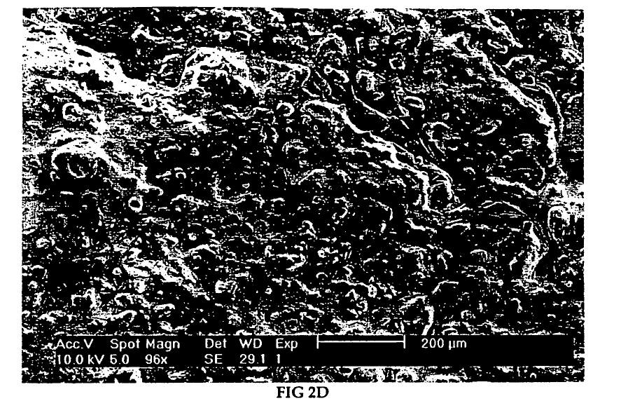

The SEM showed a visible uniform coating on the surface of the cork (FIG. 2A). The coating was also visible in cracks on the surface of the cork (FIG. 2B). Analysis of the coating after it had been immersed in white wine for 24 hours showed that the coating was still present and intact (FIG. 2C). After compression in a commercial hand corking device, the coating still formed a continuous layer (FIG. 2D).

Washintg Procedure

Corks can be rinsed or soaked with hot or cold water, alcohol, or a mixture of both water and alcohol, before the coating is applied. This reduces the occurrence of taint and other unwanted odours by washing away any taint compounds already on the surface of the cork. It is thought that any surface taint could mix with the coating during the coating process and remain on the surface of the coating, thus contributing to, rather than preventing, the taint problem. Accordingly, it is preferable to carry out a washing procedure, eg as in EXAMPLE A, B, C or D below, prior to coating corks. The corks are then dried, eg in an oven at 40° C. for 24 hours, prior to being coated.

### EXAMPLE A

Corks spiked with 100 mg/L of TCA in absolute ethanol were arranged in a single layer and passed through streams of hot water for 30 seconds and then allowed to dry.

Sensory evaluation tests gave a rating of 2 or less.

### EXAMPLE B

Corks spiked with 100 mg/L of TCA in absolute ethanol were arranged in a single layer and passed through streams of liquid containing cold water and absolute ethanol and then allowed to dry.

Sensory evaluation tests gave a rating of 2 or less.

### EXAMPLE C

Corks spiked with 100 mg/L of TCA in absolute ethanol were completely immersed in a solution of hot water for 30 minutes and allowed to dry.

Sensory evaluation tests gave a rating of 2 or less.

### EXAMPLE D

Corks spiked with 100 mg/L of TCA in absolute ethanol were completely immersed in a solution containing a mixture of cold water and absolute ethanol.

Sensory evaluation tests gave a rating of 2 or less.

### Methods of Application

Dip Coating

The simplest application method is dip coating, involving a container filled with the coating formulation into which the substrate (such as a cork) is immersed and then withdrawn.

A typical dip coating unit consists of a bath, filled with the coating formulation, and a mechanism on which the substrate is mounted for immersion and withdrawal. It is often necessary to circulate and filter the coating to maintain a homogeneous mixture. A fixing mechanism must be designed to ensure the proper orientation of the substrate during immersion into and withdrawal from the fluid.

Spray Coating

In contrast to dip coating, spray coating operations are much less efficient and much more complicated, as well as being relatively more expensive. Precise control over the spray area is difficult so that masking of the substrate may be required. The advantages offered by these systems (eg fast application time, very uniform coating thicknesses, and the ability to apply uniform coatings to irregularly shaped objects) may, however, outweigh the drawbacks.

In a spray coating operation, the fluid is atomised into fine droplets for application to the substrate. The size of the droplets formed during atomisation can be controlled by such properties as fluid flow, fluid pressure, air pressure, solution viscosity, and surface tension. A number of different nozzle designs are used in industry, such as compressed air spray nozzles, airless spray nozzles, and hot spray systems.

Slot and Curtain Coating

Slot coating and curtain coating are more appropriate techniques for a continuous operation. The methods involve a stationary die, which delivers a layer of coating onto a substrate moving beneath it. The difference between the methods is in the way that the coating is transferred from the die to the moving substrate. The coating is spread by the slot method when the die slot is close to the substrate; but changing the orientation of the die slot relative to the conveyor and allowing the formulation to cascade is referred to as curtain coating.

Multiple slots in the die face or converging feed to a single slot can produce multilayer coatings.

Roll Coating

Roll coating is another method used in continuous manufacturing operations primarily for coating films. A substrate is fed between two rotating cylinders, while simultaneously directing the coating into the space between the cylinders. Formulation viscosity, speed of the substrate, coating flow rate, and distance between the rolls all contribute to coating thickness and uniformity. Although these systems are limited in the types of substrate that can be coated, they can rapidly produce a very uniform product.

### Methods of Curing

Thermal Cure

One of the most common methods for initiating the cross-linking of a polymer is by heating, and ovens can be incorporated into batch and continuous-mode systems. The main disadvantage in thermal curing is the wasted thermal energy when only a small amount of the applied energy is transferred to the molecules. It can also be difficult to maintain a uniform temperature throughout the oven, so that curing may be uneven.

Ultraviolet (UV) Cure

One of the most popular techniques used to initiate cross-linking is irradiation by ultraviolet light. It can be a more rapid process than thermal curing, sometimes taking less than a second to act. Very little heat is generated during the exposure, which can often be carried out at room temperature.

Electron Beam Cure

Electron beam (E-beam) radiation shares the same benefits as UV radiation, without the need for a photoinitiation. The exposure forms free radicals that cause the chain reaction.

Gamma-Radiation Cure

Yet another type of irradiation that is rapid at ambient temperatures is γ-radiation cure. Cycle times for γ-ray systems can be longer than for E-beam, at least for conventional polymer matrices, but for curing hydrophilic coatings this does not present a problem.

### Additional Technologies

Plasma Polymerisation

Thin polymer films can be deposited onto various substrates through the use of plasma polymerisation. A plasma is generated by means of electron excitation, with a gas mixture and an organic monomer. These thin films can be between a few hundred angstroms to a micrometre in thickness. Cross-linking density is usually greater than in conventionally applied coatings, and thin films exhibiting good adhesion can be laid down on virtually any type of substrate.

Surface Grafting

Surface grafting techniques incorporate some of the same general concepts as coating and curing operations but may be more appropriate where exceptionally thin surface layers are desired. Points that distinguish surface grafting from “wet” coating operations are related mainly to the formation of the modified surface layer and the general molecular structures that result. In conventional coatings, a continuous phase is formed by the reactions of the monomeric or polymeric ingredients, and is adhered to the substrate surface through secondary molecular interactions such as hydrogen bonding, London dispersive forces or acid-base interactions. Primary covalent bonding is also possible if the substrate has been pre-treated with molecular groups. In surface grafting however, the monomeric (or polymeric with reactive end groups) components react directly with a polymeric substrate. Various forms of radiation, such as UV, electron beam, and γ-rays, may be used to cause the formation of peroxide groups on the polymer surface. These are unstable so decompose, and cause initiation of polymerisation in the process.

While the present invention has been described in terms of preferred embodiments in order to facilitate better understanding of the invention, it should be appreciated that various modifications can be made without departing from the principles of the invention. Therefore, the invention should be understood to include all such modifications within its scope.

1 (Canceled)

2 (Canceled)

3 (Canceled)

4 (Canceled)

5 (Canceled)

6 (Canceled)

7 (Canceled)

8 (Canceled)

9 (Canceled)

10 (Canceled)

11 (Canceled)

12 (Canceled)

13. A method for producing a coating or diffusion layer on a substrate for use in contact with a food product or beverage, said coating or diffusion layer prevention or inhibiting passage therethrough of flavor-active or odor-active compounds, and said method comprising applying to the surface of said substrate an effective amount of copolymer comprising a flexible component and a retentive component, said flexible component being sufficiently flexible to allow the coated substrate to undergo compression and recovery and said retentive component being able to bind with or otherwise retain flavor-active or odor-active compounds.

14. A method according to claim 13, wherein said substrate is a bottle closure, packaging or wrapping material, or a bottle or other container.

15. A method according to claim 13, wherein said substrate is a natural or synthetic cork, and said coating or diffusion layer prevents or inhibits passage of flavor-active or odor-active compounds from said cork to an alcoholic beverage in contact with said cork.

16. A method according to claim 15, wherein said flexible component is sufficiently flexible to allow the coated cork to be compressed and then to recover during a bottling process.

17. A method according to claim 13, wherein said flavor-active compounds are trichloroanisoles (TCA).

18. A method according to claim 13, wherein said copolymer is a graft, alternating or block copolymer.

19. A method according to 13, wherein said flexible component is formed from silicon-based monomers.

20. A method according to 13, wherein said retentive component is selected from the group consisting of polyvinylacetate (PVA) polymers, polyurethane polymers and ionomers, terephthalate polymers, styrene-acrylonitrile (SAN)/acrylonitrile-butadiene-styrene (ABS) copolymers, vinylidene polymers, epoxy polymers, amide polymers, Bisphenol polymers, Bisphenol A (BPA)-epichlorohydrin polymers, poly (methyl) methacrylate polymers, poly(methacrylic acid) polymers, cellulose polymers, polyethylene vinyl alcohol polymers, polyethylene glycol (PEG), silane polymers and siloxane polymers.

21. A method according to 20, wherein said retentive component is a polyvinylacetate (PVA) polymer.

22. A method according to 20, wherein said retentive component is selected from the group consisting of silane and siloxane polymers comprising functionalities selected from the group consisting of isoprene, butadiene, lactone, amino, terephthalate, amino acid, heterocyclic, hydride (SiH), thiol and epoxy functionalities.

23. A method according to 13, wherein said flexible component is selected from the group consisting of silane polymers, siloxane polymers, polybutadiene, polyethylene and polyacrylate.

24. A coated substrate produced according to the method of 13.

25. A coated cork produced according to the method of 13.
